(19) United States
(12) Patent Application Publication
(10) Pub. No.: US 2008/0040890 A1
(43) Pub. Date: Feb. 21, 2008

(54) Grip for bicycle handlebarbars

(75) Inventor: Chun-Fu Chang, Taichung County (TW)

Correspondence Address: Chun-Fu Chang, P.O.Box 44-2049, Taipei, 10668, omitted

(73) Assignee: MING-HSING LEATHER CO., LTD.

(21) Appl. No.: 11/785,934

(22) Filed: Apr. 23, 2007

(30) Foreign Application Priority Data
Jun. 15, 2006 (CN) 200620120051.9

(51) Int. Cl. B60N 3/02

(52) U.S. Cl. 16/421

(57) ABSTRACT

A grip for a handlebar of bicycles includes an operation layer which includes a porous PU layer and a non-woven layer which is securely attached to an underside of the porous PU layer. The operation layer is securely mounted to a sleeve and the handlebar is inserted into the sleeve. The operation layer provides shock-absorbing, non-slip and comfortable grasp to the handlebar.

### BACKGROUND OF THE INVENTION

(1) Field of the Invention

The present invention relates to a grip for bicycle handlebars and the grip provides shock-absorbing, non-slip and comfortable grasp.

(2) Description of the Prior Art

A conventional grip 2 mounted on a bicycle or motorbike handlebar is shown in FIG. 1 and generally includes a closed end and an open end into which the handlebar 1 is inserted. The grip 2 is made by plastic material and the user's hand might slip because of sweat. In order to provide comfortable and reliable grasp to the grip 2, bosses or raised patterns are made on the outer surface of the grip 2 so as to increase the friction between the grip 2 and the user's hand. However, the user need more comfortable and non-slip grip during severe operation of the bicycle.

The present invention intends to provide a grip for the bicycle or motorbike handlebar and includes a porous PU layer and a non-woven layer and the user's hand holds on the PU layer to obtain better grasp to the handlebar.

### SUMMARY OF THE INVENTION

The present invention relates to a combination of a grip and a handlebar of bicycles, wherein the grip includes a porous PU layer and a non-woven layer which is securely attached to an underside of the porous PU layer so as to form an operation layer. The operation layer is securely mounted to a sleeve and the handlebar is inserted into the sleeve.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional grip on a handlebar;

FIG. 2 is an exploded view to show the grip and the handlebar of the present invention;

FIG. 3 is a perspective view to show the grip and the handlebar of the present invention;

FIG. 4 is a cross sectional view to show the grip and the handlebar of the present invention;

FIG. 5 is an enlarged cross sectional view to show the end member, the operation layer, the sleeve and the handlebar of the present invention;

FIG. 6 is an end cross sectional view along line 6-6 of FIG. 3;

FIG. 7 is a second embodiment of the grip and the handlebar of the present invention;

FIG. 8 shows that the extension section of the sleeve in FIG. 7 flips reversely the to mount on an end of the operation layer;

FIG. 9 is a cross sectional view to show a third embodiment of the grip and the handlebar of the present invention;

FIG. 10 shows a fourth embodiment of the grip and the handlebar of the present invention;

FIG. 11 shows a cross sectional view of the operation layer in the fourth embodiment;

FIG. 12 shows a fifth embodiment of the grip and the handlebar of the present invention;

FIG. 13 shows that the extension section of the sleeve in FIG. 12 flips reversely the to mount on an end of the operation layer;

FIG. 14 shows a sixth embodiment of the grip and the handlebar of the present invention;

FIG. 15 shows a seventh embodiment of the grip and the handlebar of the present invention;

FIG. 16 is a cross sectional view of the operation layer in FIG. 15;

FIG. 17 shows an eighth embodiment of the grip and the handlebar of the present invention;

FIG. 18 shows that the extension section of the sleeve in FIG. 17 flips reversely the to mount on an end of the operation layer;

FIG. 19 shows a ninth embodiment of the grip and the handlebar of the present invention;

FIG. 20 shows two bands of the operation layer of a tenth embodiment of the grip and the handlebar of the present invention;

FIG. 21 shows the two bands in FIG. 20 are connected to each other;

FIG. 22 shows two bands of the operation layer of an eleventh embodiment of the grip and the handlebar of the present invention;

FIG. 23 shows the two bands in FIG. 22 are connected to each other, and

FIG. 24 is a cross sectional view to show a twelfth embodiment of the grip and the handlebar of the present invention.

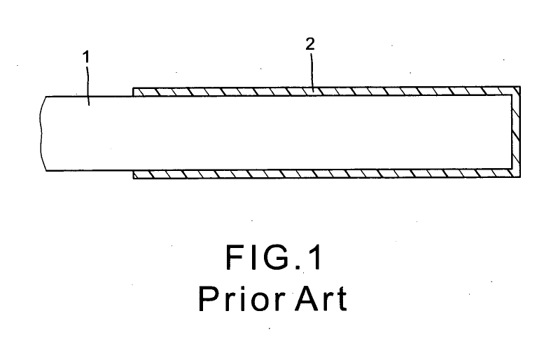

### DETAILED DESCRIPTION OF THE PREFERRED EMBODIMENTS

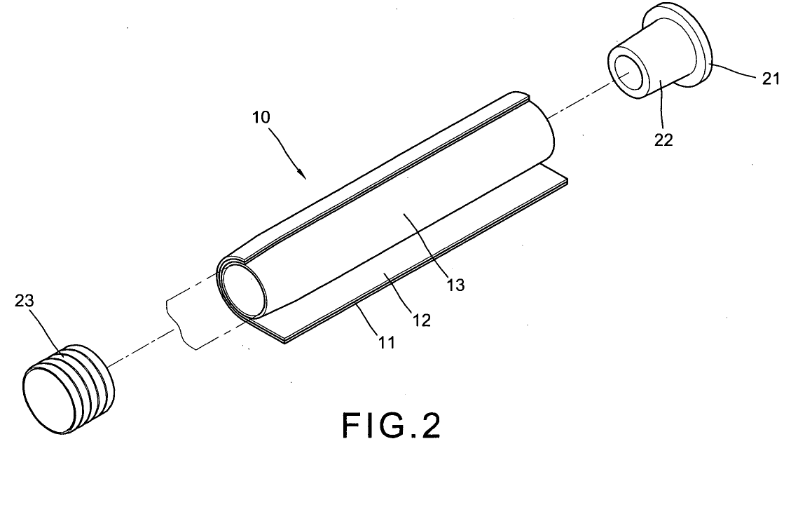

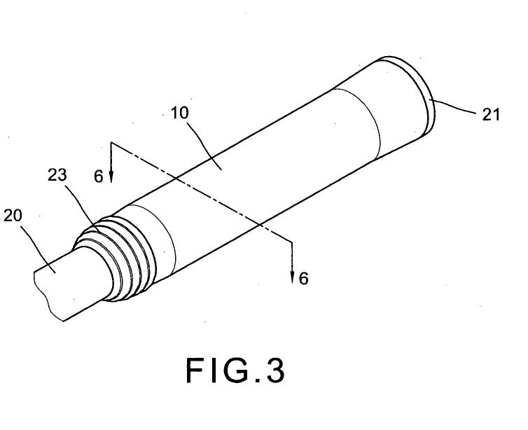

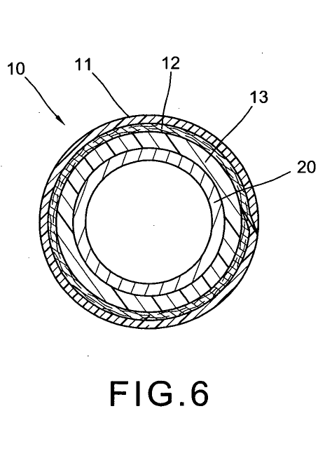

Referring to FIGS. 2 to 6, the grip of the present invention comprises a porous Polyurethane (PU) layer 11 and a non-woven layer 12 which is securely attached to an underside of the porous PU layer 11 so as to form an operation layer 10. The operation layer 10 is securely mounted to a sleeve 13 by a layer of adhesive (not shown) on the non-woven layer 12. A releasing layer (not shown) can be used on the adhesive so that the assembler can peel the releasing layer to securely mount the operation layer to the sleeve 13. A handlebar 20 is inserted into the sleeve 13.

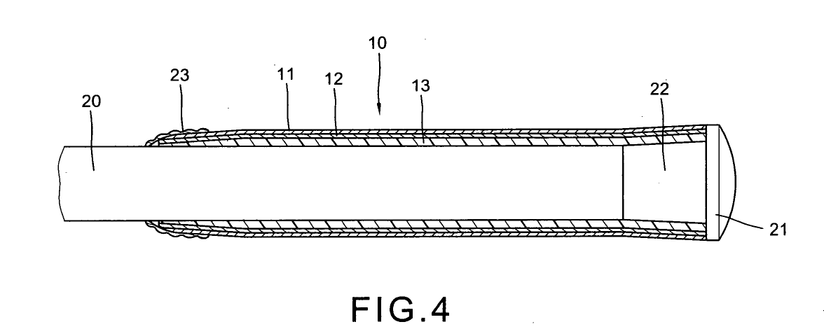

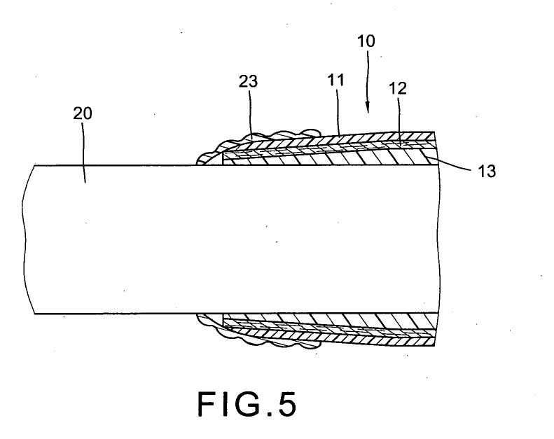

An end member 23 made by elastic material is mounted to an end of the sleeve 13 and an end of the operation layer 10 as shown in FIGS. 4 and 5. An end stop includes an end disk 21 and a tubular portion 22 extends perpendicularly from a surface of the end disk 21, the tubular portion 22 includes a tapered outer periphery and is inserted into an end of the sleeve 13.

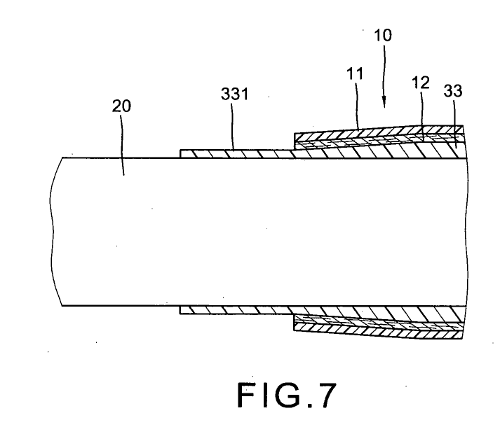

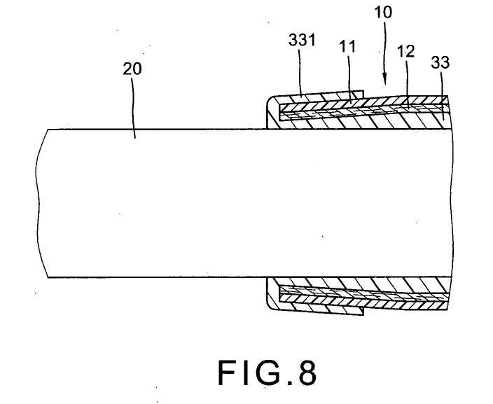

FIGS. 7 and 8 disclose a second embodiment of the grip and the handlebar of the present invention, wherein an extension section 331 extends axially from an end of the sleeve 13 and flips reversely to mount onto an end of the operation layer 10. The end member 23 in FIG. 2 can be omitted in this embodiment.

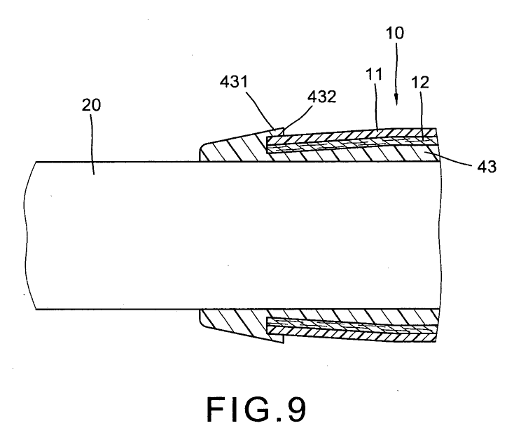

FIG. 9 shows a third embodiment of the grip and the handlebar of the present invention, wherein the sleeve 43 includes a head 431 which includes an annular groove 432 defined in an end surface thereof and an end of the operation layer 10 is inserted into the annular groove 432.

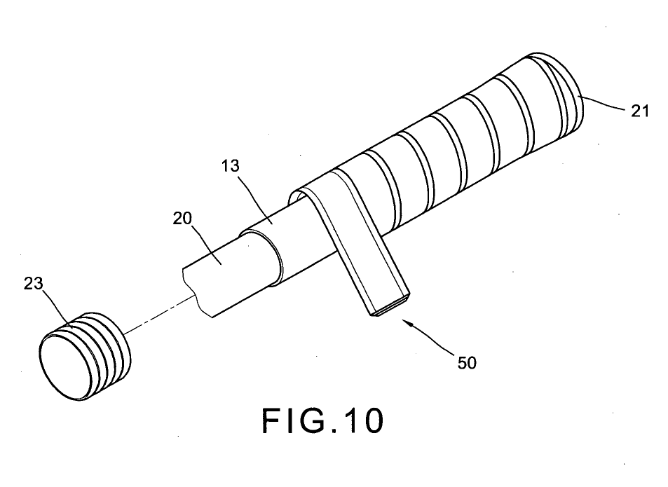

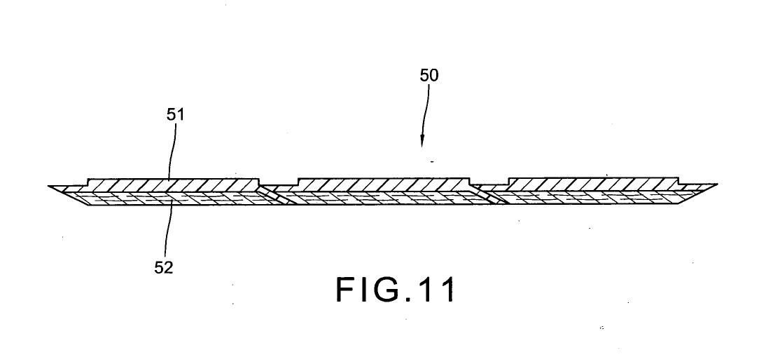

FIGS. 10 and 11 show a fourth embodiment of the grip and the handlebar of the present invention wherein the operation layer 50 is a band which is composed of the PU layer 51 and the non-woven layer 52, and is wrapped around the sleeve 13. The operation layer 50 has a width that is smaller than the operation layer 10 in FIG. 2 and is wrapped on the sleeve 13 as shown. The end member 23 and the end stop are connected on two ends of the sleeve 13 as previously described in the three embodiments.

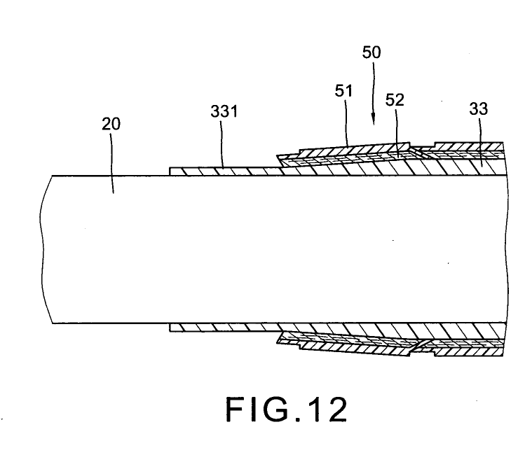

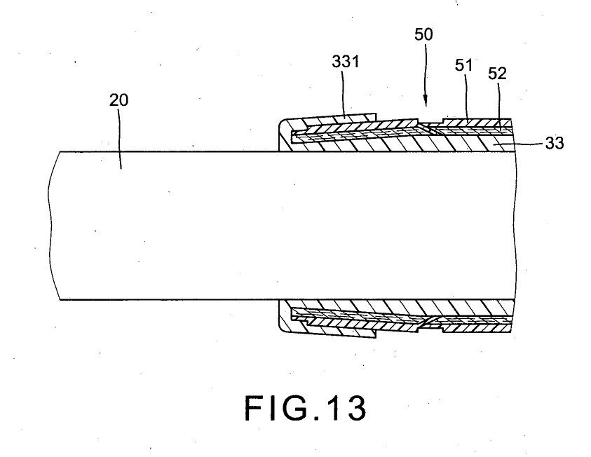

FIGS. 12 and 13 show a fifth embodiment of the grip and the handlebar of the present invention, wherein the extension section 331 of the sleeve 33 flips reversely to mount on an end of the operation layer 50.

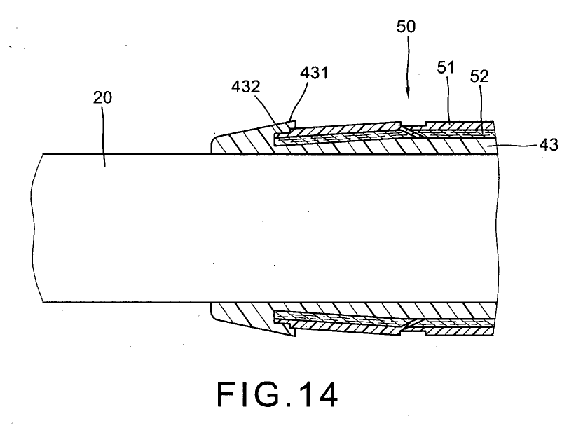

FIG. 14 shows a sixth embodiment of the grip and the handlebar of the present invention, wherein the sleeve 43 includes a head 431 which includes an annular groove 432 defined in an end surface thereof and an end of the operation layer 50 is inserted into the annular groove 432.

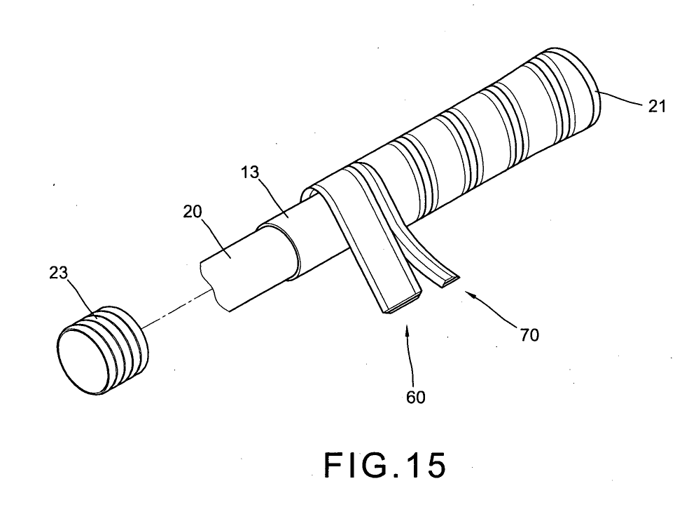

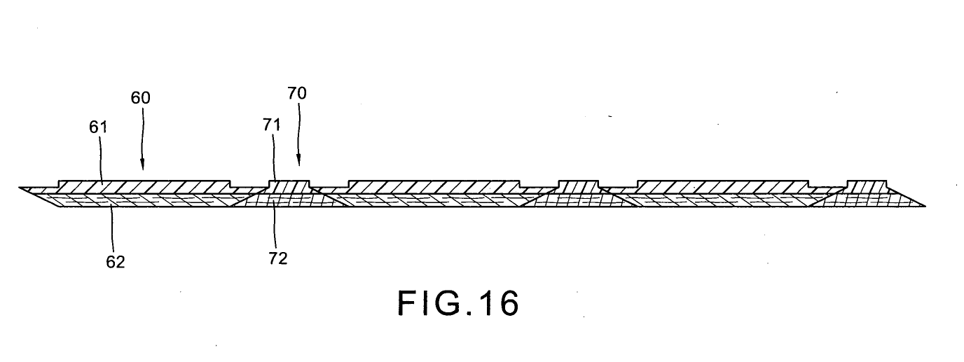

FIGS. 15 and 16 show a seventh embodiment of the grip and the handlebar of the present invention, wherein the operation layer includes two bands 60, 70 which are wrapped to the sleeve 13 and two respective adjacent sides of the at least two bands 60, 70 are overlapped to each other. The two bands 60, 70 have different widths and each include a PU layer 71/61 and a non-woven layer 72/62.

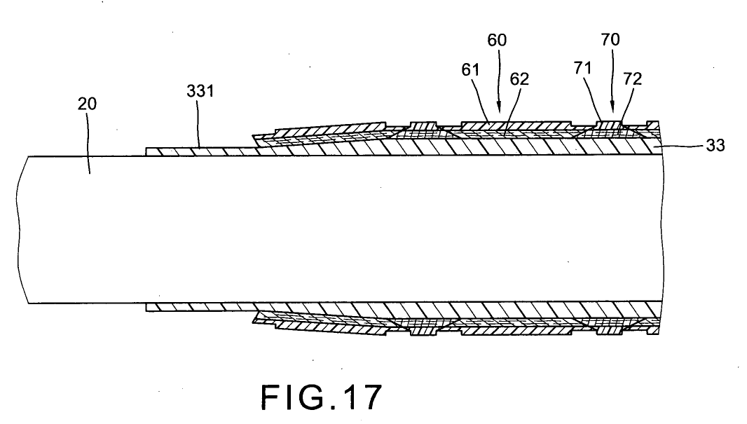

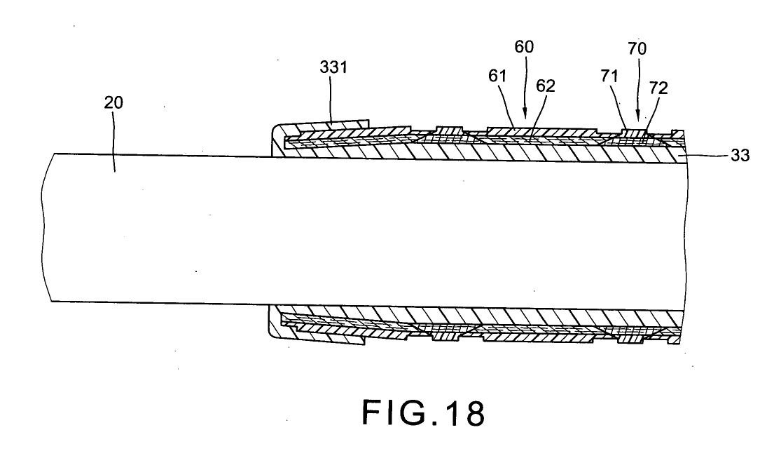

FIGS. 17 and 18 show an eighth embodiment of the grip and the handlebar of the present invention, wherein the operation layer includes two bands 60, 70 and the extension section 331 of the sleeve 33 flips reversely the to mount on an end of the operation layer.

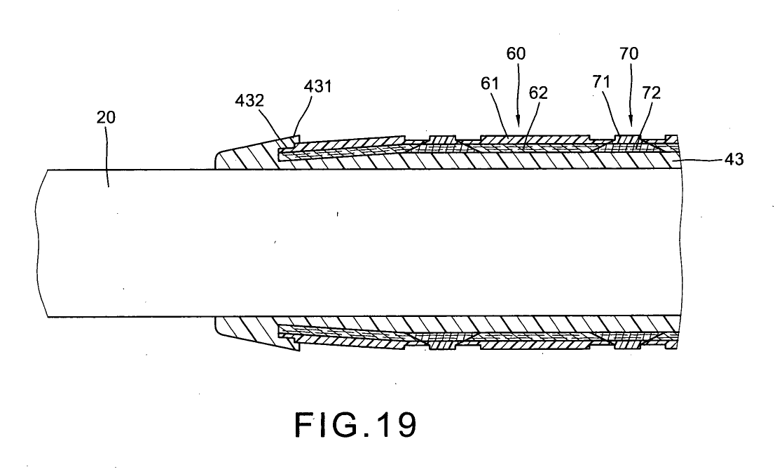

FIG. 19 show a ninth embodiment of the grip and the handlebar of the present invention, wherein the sleeve 43 includes a head 431 which includes an annular groove 432 defined in an end surface thereof and an end of the operation layer composed of the two bands 60, 70 is inserted into the annular groove 432.

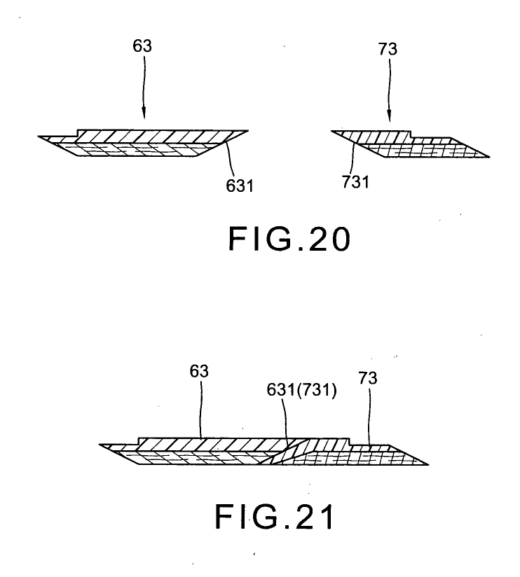

FIGS. 20 and 21 show a tenth embodiment of the grip and the handlebar of the present invention, wherein the two bands 63, 73 each have two inclined ends 631/731 and the two respective inclined ends 631, 731 have the same inclination but opposite slopes so that the two respective inclined ends 631, 731 are matched to each other. Each of the two bands 63, 73 includes a serrated top surface to increase its friction to the user's hand.

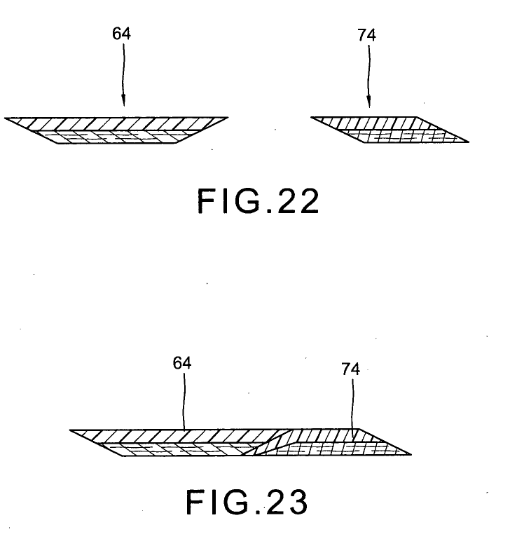

FIGS. 22 and 23 show a eleventh embodiment of the grip and the handlebar of the present invention, wherein the two bands 64, 74 each have two inclined ends and the two respective inclined ends have the same inclination but opposite slopes so that the two respective inclined ends are matched to each other. Each of the two bands 64, 74 includes a smooth top surface.

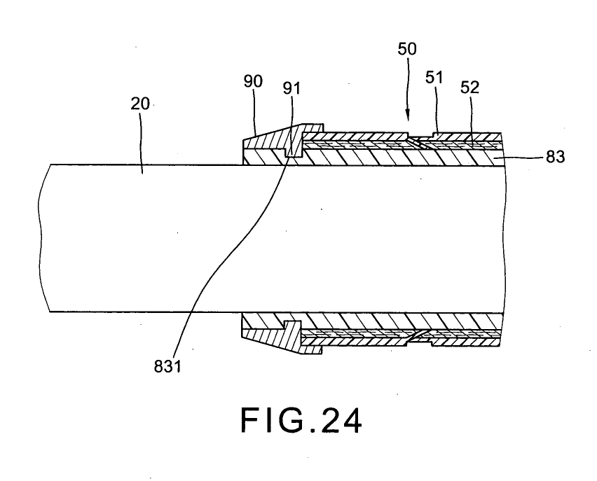

FIG. 24 shows a twelfth embodiment of the grip and the handlebar of the present invention, wherein the sleeve 83 includes an engaging groove 831 defined radially in an outer periphery thereof and an end member 90 is mounted to an end of the sleeve 83 and an end of the in the art that further embodiments may be made without departing from the scope of the present invention.

What is claimed is:

1. A combination of a grip and a handlebar of bicycles, wherein the grip includes a porous Polyurethane (PU) layer and a non-woven layer which is securely attached to an underside of the porous PU layer so as to form an operation layer, the operation layer is securely mounted to a sleeve and the handlebar is inserted into the sleeve.

2. The combination as claimed in claim 1, wherein an end member is mounted to an end of the sleeve and an end of the operation layer, the end member is made by elastic material.

3. The combination as claimed in claim 1, wherein an extension section extends axially from an end of the sleeve and flips reversely to mount onto an end of the operation layer.

4. The combination as claimed in claim 1, wherein the sleeve includes a head which includes an annular groove defined in an end surface thereof and an end of the operation layer is inserted into the annular groove.

5. The combination as claimed in claim 1, an end stop includes an end disk and a tubular portion extends perpendicularly from a surface of the end disk, the tubular portion includes a tapered outer periphery and is inserted into an end of the sleeve.

6. The combination as claimed in claim 1, wherein the sleeve includes an engaging groove defined radially in an outer periphery thereof and an end member is mounted to an end of the sleeve and an end of the operation layer, the end member includes a protrusion which is engaged with the engaging groove.

7. The combination as claimed in claim 1, wherein the operation layer includes at least two bands which are wrapped to the sleeve and two respective adjacent sides of the at least two bands are overlapped to each other.

8. The combination as claimed in claim 1, wherein the at least two bands have different widths.
